(19) United States
(12) Patent Application Publication
(10) Pub. No.: US 2018/0062826 A1
(43) Pub. Date: Mar. 1, 2018

(54) RADIO COMMUNICATION DEVICE AND INTEGRATED CIRCUITRY

(71) Applicant: KABUSHIKI KAISHA TOSHIBA, Minato-ku (JP)

(72) Inventors: Hidenori OKUNI, Yokohama (JP); Akihide SAI, Yokohama (JP); Masanori FURUTA, Odawara (JP); Satoshi KONDO, Kawasaki (JP); Tuan Thanh TA, Kawasaki (JP)

(73) Assignee: KABUSHIKI KAISHA TOSHIBA, Minato-ku (JP)

(21) Appl. No.: 15/461,809

(22) Filed: Mar. 17, 2017

(30) Foreign Application Priority Data
Aug. 30, 2016 (JP) 2016-168362

(51) Int. Cl. H04L 7/00; H04B 1/16

(52) U.S. Cl. CPC H04L 7/0079; H04B 1/16

(57) ABSTRACT

A radio communication device has an analog control loop unit to generate an analog control signal, a digital control loop unit which has a frequency determined with the frequency of a reference signal and a predetermined frequency setting code signal, a voltage controlled oscillator to generate the voltage control oscillation signal, a data slicer to generate a digital signal obtained by digitally demodulating the reception signal, an automatic offset controller to generate a correction signal, a setting code adjuster to adjust the frequency setting code signal, based on the correction signal, and a direct-current level adjuster to adjust a direct-current level of the digital control signal, based on the correction signal. The data slicer compares the digital control signal adjusted by the direct-current level adjuster, with the threshold value.

### CROSS REFERENCE TO RELATED APPLICATIONS

This application is based upon and claims the benefit of priority from the prior Japanese Patent Application No. 2016-168362, filed on Aug. 30, 2016, the entire contents of which are incorporated herein by reference.

### FIELD

Embodiments of the present disclosure relate to a radio communication device and integrated circuitry.

### BACKGROUND

A receiver having a frequency tracking function has been proposed. The frequency tracking function detects a shift between a timing when a reception signal intersects with a threshold voltage of a data slicer and a desired timing, and performs feed-back control so that the shift is removed.

When control of correctly tracking the frequency drift of the reception signal is performed, the shift between the reference signal level of the reception signal and the threshold value of the data slicer increases so that there is a likelihood that it is impossible to fully accomplish the frequency tracking function.

### BRIEF DESCRIPTION OF THE DRAWINGS

FIG. 1A is a block diagram showing a schematic configuration of a receiver according to a first embodiment;

FIG. 1B is a block diagram showing one modification of FIG. 1A;

FIGS. 2A to 2E are signal waveform charts according to the first embodiment;

FIG. 3 is a block diagram showing a schematic configuration of a receiver according to a second embodiment;

FIGS. 4A and 4B are signal waveform charts according to the second embodiment;

FIG. 5 is a block diagram showing a schematic configuration of a receiver according to a third embodiment;

FIGS. 6A to 6C are signal waveform charts according to the third embodiment;

FIG. 7 is a block diagram showing a schematic configuration of a receiver according to a fourth embodiment;

FIGS. 8A to 8C are signal waveform charts according to the fourth embodiment;

FIG. 9 is a block diagram showing a schematic configuration of a radio communication device according to a fifth embodiment;

FIG. 10 is a block diagram showing one modification of FIG. 9;

FIG. 11 is a view of exemplary radio communication between a PC and a mouse; and

FIG. 12 is a view of exemplary radio communication between the PC and a wearable terminal.

### DETAILED DESCRIPTION

According to one embodiment, a radio communication device has:

an analog control loop unit to generate an analog control signal which adjusts the phase of a voltage control oscillation signal, from a signal including a reception signal converted in frequency;

a digital control loop unit which has a frequency determined with the frequency of a reference signal and a predetermined frequency setting code signal, has gain higher than the gain of the analog control loop unit, and generate a digital control signal;

a voltage controlled oscillator to generate the voltage control oscillation signal, based on the analog control signal and the digital control signal;

a data slicer to generate a digital signal obtained by digitally demodulating the reception signal, based on a comparison between the digital control signal and a threshold value;

an automatic offset controller to generate a correction signal in response to an error between the frequency of the reception signal and the frequency of the voltage control oscillation signal, based on a time difference between a timing when the digital control signal is equivalent to the threshold value of the data slicer and an ideal timing;

a setting code adjuster to adjust the frequency setting code signal, based on the correction signal; and

a direct-current level adjuster to adjust a direct-current level of the digital control signal, based on the correction signal,

wherein the data slicer compares the digital control signal adjusted by the direct-current level adjuster, with the threshold value.

Embodiments of the present disclosure will be described in detail below with reference to the drawings.

### First Embodiment

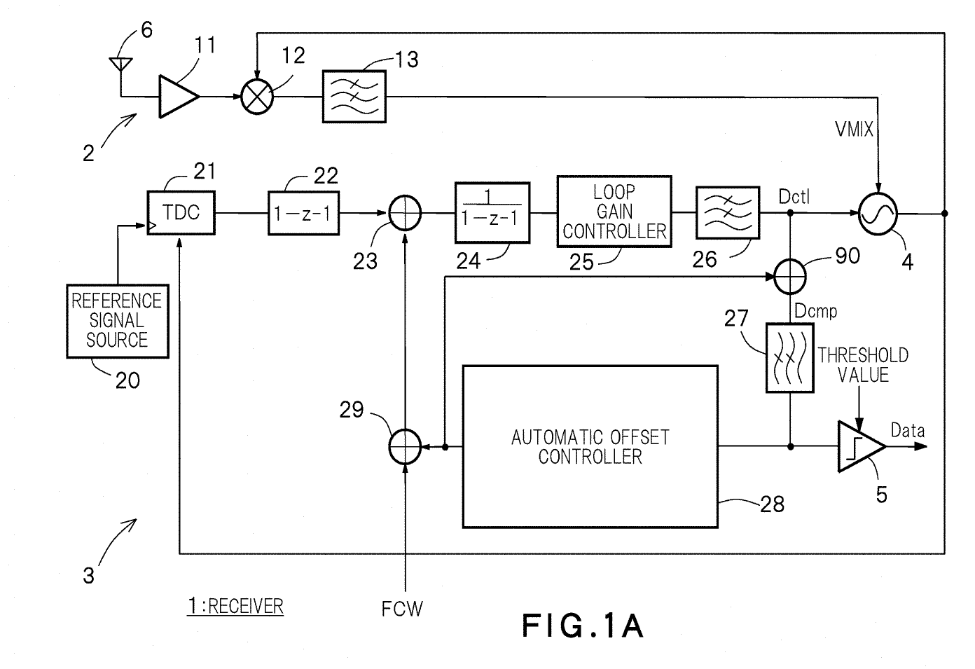

FIG. 1A is a block diagram showing a schematic configuration of a receiver 1 in a radio communication device according to a first embodiment. The receiver 1 in FIG. 1A includes an analog control loop unit 2, a digital control loop unit 3, a voltage controlled oscillator 4, and a data slicer 5. The receiver 1 in FIG. 1A is used, for example, when a PSK signal is received.

The analog control loop unit 2 includes a low-noise amplifier 11 that amplifiers a reception signal received through an antenna 6, a frequency converter 12 that converts the signal in frequency, a low pass filter 13 that removes an unnecessary signal, to generate an analog control signal Vctl for adjusting the phase of a voltage control oscillation signal.

The digital control loop unit 3 has a frequency determined with the frequency of a reference signal and a predetermined frequency setting code signal (FCW: Frequency Command Word). The digital control loop unit 3 is capable of reducing the swing of the analog control signal Vctl to be input to the voltage control oscillation signal, and generates a digital control signal Dctl having a phase substantially opposite to that of the analog control signal Vctl.

The analog control loop unit 2 controls the frequency of the voltage control oscillation signal to track the reception signal, whereas the digital control loop unit 3 intercepts the control of the analog control loop unit 2 and controls the frequency of the voltage control oscillation signal to track the setting frequency determined with the reference signal and the frequency setting code signal. As a result of this type of reciprocal control, the analog control signal Vctl generated by the analog control loop unit 2 and the digital control signal Dctl generated by the digital control loop unit each have a phase difference of approximately 180° therebetween.

The voltage controlled oscillator (VCO) 4 generates the voltage control oscillation signal (hereinafter, referred to as a VCO signal) based on the analog control signal Vctl and the digital control signal Dctl.

The digital control loop unit 3 includes a reference signal source 20, a time-to-digital converter (TDC) 21, a digital differentiator 22, a digital subtractor 23, an integrator 24, a loop gain controller (a second loop gain controller) 25, a loop filter 26, a channel selection filter 27, an automatic offset controller 28, a setting code adjuster 29, and a direct-current level adjuster 90.

The time-to-digital converter 21 detects the phase of the VCO signal in synchronization with the reference signal FREF from the reference signal source 20.

The digital differentiator 22 performs differential processing to an output signal of the time-to-digital converter 21 to convert a signal indicating the phase of the VCO signal into a frequency signal.

The digital subtractor 23 detects the difference between an output signal of the digital differentiator 22 and the frequency setting code signal FCW to generate a frequency error signal.

The integrator 24 converts the frequency error signal generated by the digital subtractor 23, into a phase error signal. The phase error signal is input to the loop gain controller 25.

The loop gain controller 25 operates as a type II ADPLL, for example. The loop gain of the type II ADPLL attenuates with a second-order gradient toward the high frequency side. Therefore, the loop filter 26 is arranged at a subsequent stage of the loop gain controller 25. The loop filter 26 removes a frequency component higher than the reception signal in the receiver 1 and performs smoothing to generate the digital control signal Dctl.

The direct-current level adjuster 90 is coupled to a subsequent stage of the loop filter 26 to adjust the direct-current level (the average) of the digital control signal Dctl, based on a correction signal of the output of the automatic offset controller 28, as described later.

The channel selection filter 27 is coupled to a subsequent stage of the direct-current level adjuster 90 to suppress a disturbing wave component included in the digital control signal Dctl. The disturbing wave component to be suppressed is mainly in proximity to a channel selection frequency. The digital control signal Dctl that has passed through the channel selection filter 27 is input to the data slicer 5.

The data slicer 5 compares the digital control signal Dctl with a predetermined threshold voltage to perform data demodulation in response to the reception signal.

The digital control loop unit 3 includes an all digital (AD) PLL. The descriptions of the operation principle of the ADPLL will be omitted. The setting frequency FVCO in the digital control loop unit 3 is expressed by Expression (1) below:

FVCO=FCW×FREF (1)

where FREF represents the frequency of the reference signal.

The receiver 1 in FIG. 1A synchronizes the setting frequency

FVCO expressed by Expression (1) with the carrier frequency of the reception signal to set a communication channel.

The receiver 1 sets the loop gain of the digital control loop unit 3 to be sufficiently higher than the loop gain of the analog control loop unit 2. Accordingly, the analog control signal Vctl generated by the analog control loop unit 2 and the digital control signal Dctl generated by the digital control loop unit 3 each have a phase difference of approximately 180° therebetween. That is, the digital control loop unit 3 performs an operation of intercepting the operation of the analog control loop unit 2. As a result, the analog control signal Vctl and the digital control signal Dctl mutually have a substantially exact opposite (reverse) phase. The digital control signal Dctl is determined to be 1 (or 0) when operating toward the plus side, and the digital control signal Dctl is determined to be 0 (or 1) when operating toward the minus side, so that a BPSK signal can be demodulated.

The digital control signal Dctl is input to the voltage controlled oscillator 4 and the direct-current level adjuster 90. The direct-current level adjuster 90 adjusts the direct-current level (the average) of the digital control signal Dctl. The output signal of the direct-current level adjuster 90 is input to the channel selection filter 27 to remove an unnecessary signal. The data slicer 5 including a digital comparator operated by a reference clock synchronized with a symbol rate demodulates the output signal of the channel selection filter 27. By setting a threshold value of the digital comparator to an appropriate level, 1 (or 0) and 0 (or 1) of the digital control signal Dctl can be determined.

The output signal of the channel selection filter 27 is also input to the automatic offset controller 28. The automatic offset controller 28 generates the correction signal in response to the error between the carrier wave frequency of a transmitter and the frequency of the VCO signal, based on the time difference between a timing when the digital control signal Dctl is equivalent to the threshold value of the data slicer 5 and a desired timing. Here, the desired timing satisfies the following expression: kT+0.5 T where T represents the length of a symbol (time between symbols) and kT represents a timing for determining the symbol (k is an integer). That is, the timing shifts from the timing for determining the symbol by 0.5 T.

The setting code adjuster 29 adjusts the frequency setting code signal based on the correction signal.

The receiver 1 according to the present embodiment originally has no concept of an in-phase signal and a quadrature signal, and can demodulate the reception signal to which FSK/BPSK modulation has been performed, correcting the frequency offset between a transmitter and the receiver 1 with only one of signal paths.

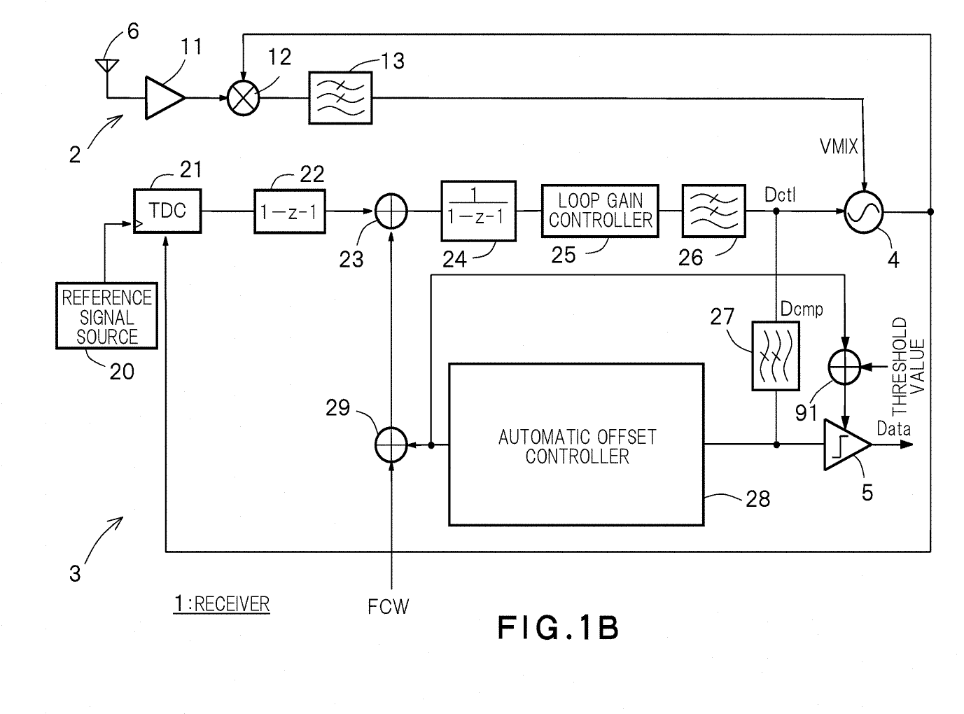

FIG. 2A illustrates signal waveforms of the digital control signal Dctl and the analog control signal Vctl according to the first embodiment when the frequency offset is present between the transmitter and the receiver 1 that transmits and receives the BPSK signal, respectively, and when the frequency offset is not present. FIG. 2B illustrates signal waveforms of an output signal Dcmp of the direct-current level adjuster 90 and the analog control signal Vctl according to the first embodiment when the frequency offset is present between the transmitter and the receiver 1 that transmits and receives the BPSK signal, respectively, and when the frequency offset is not present. FIG. 2C is a signal waveform chart of the setting frequency FVCO in the digital control loop unit 3.

Solid line waveforms in FIGS. 2A and 2B are ideal signal waveforms, and the threshold value of the data slicer 5 intersects at a substantially center of the amplitude of the digital control signal Dctl or the amplitude of the output signal Dcmp of the direct-current level adjuster 90.

Here, when the frequency offset is present between the transmitter and the receiver 1, for example, the ideal signal waveforms shift in frequency as broken line waveforms so that the shift in frequency gradually accumulates to generate a phase error. That is, when the frequency offset is present, the phase error obtained by accumulating the frequency offset increases. Therefore, the automatic offset controller 28 detects the increase of the phase error for each symbol, namely, the differential value of the digital control signal Dctl, to regard the differential value as the correction signal. Then, the setting code adjuster 29 adds the correction signal to a frequency setting input code signal input to the receiver 1 to adjust the frequency setting code signal. The adjusted frequency setting code signal is input to the digital subtractor 23. Accordingly, the setting frequency FVCO of the digital control loop unit 3 gradually comes close to a desired frequency FRF, as illustrated in FIG. 2C. Therefore, the frequency of the VCO signal of the voltage controlled oscillator 4 and the frequency of the reception signal can be synchronized.

When the automatic offset controller 28 detects the amount of the phase error due to the shift in frequency and the setting code adjuster 29 adjusts the frequency setting code signal based on the correction signal, the direct-current level (the average) of the digital control signal Dctl also varies according to the correction signal of the shift in frequency (refer to FIG. 2A). When the variation (a frequency error correction amount) is large, the direct-current level (the average) of the digital control signal Dctl shifts from the threshold value. The direct-current level adjuster 90 corrects the direct-current level (the average) of the digital control signal Dctl, based on the correction signal resulting from the detection of the amount of the phase error due to the shift in frequency, by the automatic offset controller 28, so that the direct-current level (the average) of the output signal Dcmp of the direct-current level adjuster 90 can be constant and the data demodulation and the detection of the shift in frequency can be performed. In this manner, the direct-current level adjuster 90 adjusts the direct-current level of the digital control signal Dctl that has been input, in order to make the direct-current level of the digital control signal Dctl that has been adjusted, constant.

As illustrated in FIG. 2B, the automatic offset controller 28 detects the amount of the phase error due to the shift in frequency, and the direct-current level adjuster 90 corrects the direct-current level (the average) of the digital control signal Dctl based on the correction signal so that the direct-current level (the average) of the output signal Dcmp of the direct-current level adjuster 90 does not shift even when the setting code adjuster 29 adjusts the frequency setting code signal. Accordingly, even when the frequency error correction amount is large, the data demodulation can be performed and furthermore the shift in frequency can be detected.

In this manner, according to the first embodiment, the direct-current level adjuster 90 is provided to correct the direct-current level (the average) of the digital control signal Dctl so that the correction signal is generated in response to the error between the frequency of the reception signal and the frequency of the VCO signal, based on the time difference between the timing when the digital control signal Dctl and the threshold value of the data slicer 5 are equivalent to each other and the desired timing. Thus, feedback control is performed to the digital control signal Dctl and the direct-current level adjuster 90 with the correction signal so that the frequency of the reception signal and the frequency of the VCO signal can conform to each other. Therefore, the frequency offset between the transmitter and the receiver 1 can be offset.

According to the present embodiment, the frequency offset can be corrected without a digital PLL circuitry including an IQ demodulator and an angle arithmetic circuitry so that a circuitry scale can be reduced and power consumption can be also reduced.

Furthermore, the receiver 1 in FIG. 1A performs the digital conversion by using the time-to-digital converter 21 inside the digital control loop unit 3 so that an A/D converter that is originally required to be at a subsequent stage of the frequency converter 12 is not required and the internal configuration can be simplified.

The receiver 1 in FIG. 1A has tolerance significantly high against the disturbing wave in comparison to a conventional analog synchronous FSK/PSK receiver. The higher the loop gain of the digital control loop unit 3 increases than the loop gain of the analog control loop unit 2, the more the voltage controlled oscillator 4 can be prevented from being involved into the frequency of the disturbing wave even when the disturbing wave having large power is present.

Furthermore, the loop gain of the digital control loop unit 3 is higher toward the low frequency (the carrier frequency) side and is lower toward the high frequency (the disturbing wave frequency) side so that an unnecessary component due to the disturbing wave can be suppressed by the gain difference therebetween.

The receiver 1 in FIG. 1A can generate a digital signal digitally demodulated by the data slicer 5 and no additional digital demodulator is required so that the internal configuration of the receiver 1 can be simplified.

In this manner, in the receiver 1 of the radio communication device according to the first embodiment, the direct-current level adjuster 90 corrects the variation of the direct current level (the average) of the output Dcmp of the direct-current level adjuster 90 due to the adjustment in frequency with the frequency setting code signal. Accordingly, demodulation processing of reception data can be correctly performed and additionally the frequency offset between the transmitter and the receiver 1 can be offset.

FIG. 1B is a block diagram of a receiver 1 according to one modification of the first embodiment. The receiver 1 in FIG. 1B includes a threshold value adjuster 91 instead of the direct-current level adjuster 90 of FIG. 1A. The threshold value adjuster 91 adjusts a threshold value to be used by a data slicer 5, based on a correction signal generated by an automatic offset controller 28. In more detail, the threshold value adjuster 91 adjusts the threshold value in response to the variation of the direct-current level of a digital control signal Dctl. According to the receiver 1 in FIG. 1B, even when the direct-current level of the digital control signal Dctl varies, the threshold value also varies in accordance with the variation. Thus, a data slicer 5 can generate a digital signal including a reception signal digitally demodulated, without influence due to the variation of the direct-current level of the digital control signal Dctl. Therefore, the receiver 1 in FIG. 1B can acquire an effect the same as that of the receiver 1 in FIG. 1A.

FIG. 2D illustrates signal waveforms of the digital control signal Dctl and an analog control signal Vctl in a case where the threshold value adjuster 91 controls the threshold value when a frequency offset is present between a transmitter and the receiver 1 that transmits and receives a BPSK signal, respectively, and when the frequency offset is not present, in the one modification of the first embodiment (refer to FIG. 1B). FIG. 2E is a signal waveform chart of the setting frequency FVCO in a digital control loop unit 3. Even when the direct-current level (the average) of the digital control signal Dctl shifts, the threshold value adjuster 91 adjusts the threshold value so that data demodulation can be performed and furthermore the shift in frequency can be detected.

### Second Embodiment

A second embodiment to be described below has a technical feature in which an internal configuration of an automatic offset controller 28 is specified.

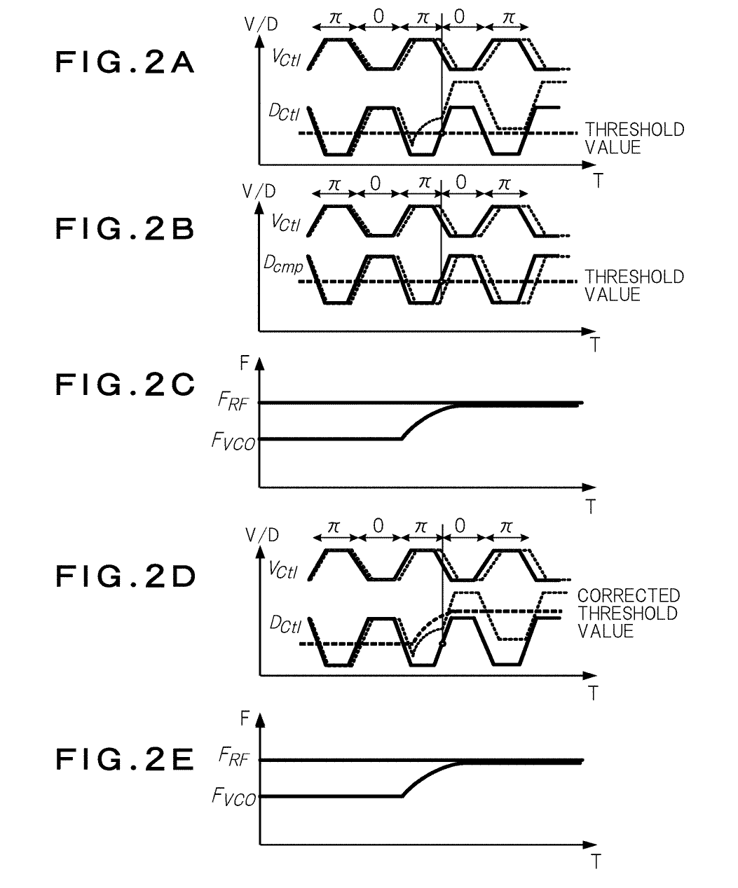

FIG. 3 is a block diagram showing an internal configuration of a receiver 1 in a radio communication device according to the second embodiment. The receiver 1 in FIG. 3 is in common with the configuration of FIG. 1A except that the internal configuration of the automatic offset controller 28 is different from that of FIG. 1A.

The automatic offset controller 28 in FIG. 3 includes an edge detector 31 and a loop gain controller (a first loop gain controller) 32. The edge detector 31 detects the time difference between a timing when an output signal Dcmp of a direct-current level adjuster 90 is equivalent to the threshold value of a data slicer 5 and a desired timing, for each symbol, to output an error signal in response to the time difference. The loop gain controller 32 generates a correction signal based on the error signal. More specifically, the loop gain controller 32 multiplies the error signal by predetermined gain to generate the correction signal. A setting code adjuster 29 adds the correction signal to a frequency setting input code signal to generate the frequency setting code signal.

In this manner, an automatic frequency correction loop includes the edge detector 31, the loop gain controller 32, the setting code adjuster 29, a digital control loop unit 3, and a voltage controlled oscillator 4. The loop can be regarded as a frequency-locked loop (FLL). Even when the frequency offset between a transmitter and the receiver 1 varies due to an external factor, the receiver 1 according to the present embodiment can correct the frequency offset, tracking the variation, by using the loop.

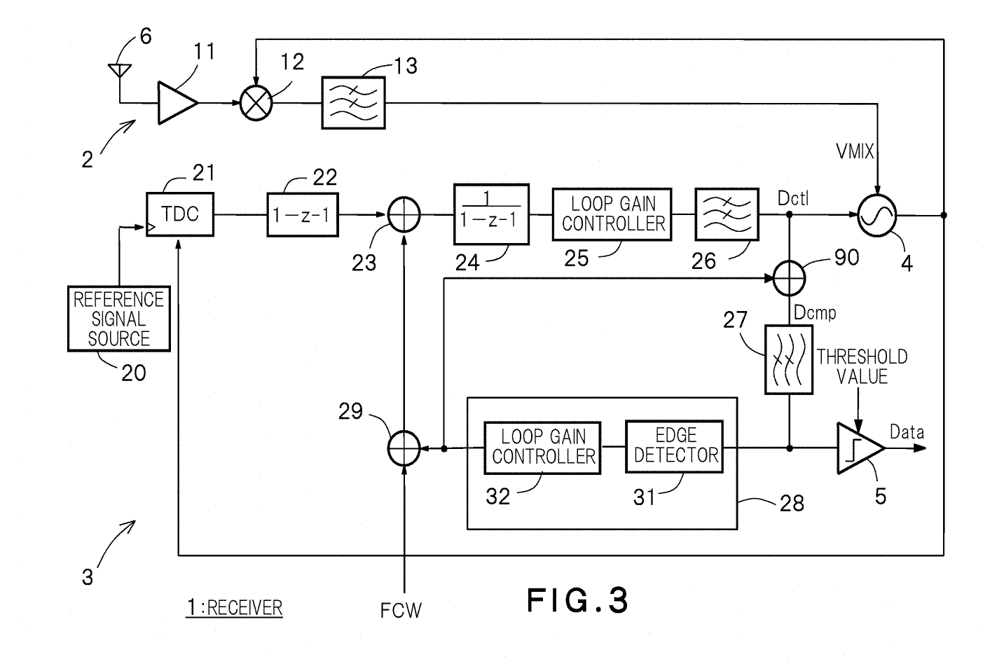

FIG. 4A illustrates signal waveforms of a digital control signal Dctl and an analog control signal Vctl according to the second embodiment when the frequency offset is present between the transmitter and the receiver 1 that transmits and receives a BPSK signal, respectively, and when the frequency offset is not present. FIG. 4B is a signal waveform chart of the setting frequency FVCO in the digital control loop unit 3.

The edge detector 31 outputs the error signal for each symbol so that the frequency offset can be adjusted for each symbol. Therefore, as illustrated in FIG. 4A, a phase error that occurs due to accumulation of the frequency offset, is smaller than that in FIG. 2A.

Note that, the edge detector 31 can detect the time difference described above, in any of a preamble section and a data section for each symbol.

Here, the loop band of the automatic offset controller 28 is made lower than the loop band of the digital control loop unit 3.

Accordingly, the correction of the frequency offset between the transmitter and the receiver 1 by the automatic offset controller 28 is gently performed so that the operation can be stabilized.

In this manner, according to the second embodiment, the automatic offset controller 28 includes the edge detector 31 and the loop gain controller 32 inside so that the correction signal can be generated for each symbol and the frequency offset can be adjusted for each symbol.

### Third Embodiment

A third embodiment to be described below is to adjust a phase offset.

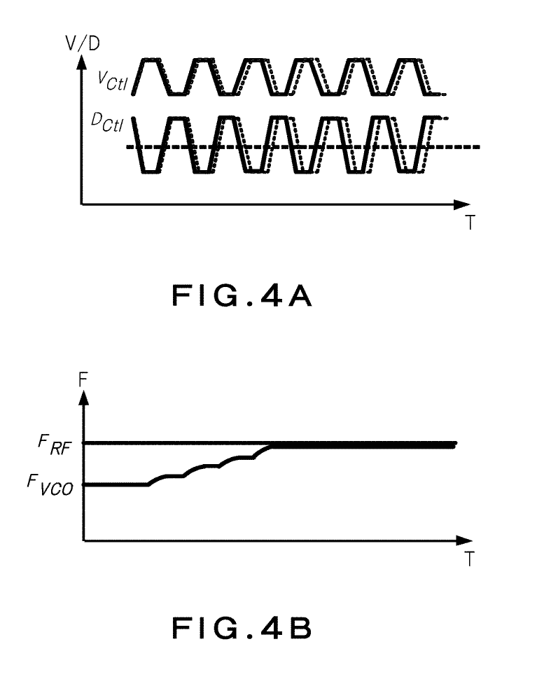

FIG. 5 is a block diagram showing an internal configuration of a receiver 1 in a radio communication device according to the third embodiment. The receiver 1 in FIG. 5 is in common with the configuration of FIG. 3 except that an internal configuration of an automatic offset controller 28 is different from that of FIG. 3. In more detail, an internal configuration of a loop gain controller 32 in the automatic offset controller 28 in FIG. 5 is different from that in FIG. 3.

An edge detector 31 in the automatic offset controller 28 in

FIG. 5 detects the time difference between a timing when an output signal Dcmp of a direct-current level adjuster 90 intersects with the threshold value of a data slicer 5 and a desired timing. The time difference can be regarded as a phase error between a transmitter and the receiver 1. The edge detector 31 detects the amount of the phase error and the polarity, generates a DN signal having a pulse width being the amount of the phase error when a phase advances, and generates an UP signal having a pulse width being the amount of the phase error when the phase delays.

The loop gain controller 32 in the automatic offset controller 28 in FIG. 5 includes a proportion path unit 32a, an integral path unit 32b, and an adder 36. The proportion path unit 32a includes a multiplier 33. The integral path unit 32b includes a multiplier 34 and an integrator 35. The adder 36 adds an output signal of the proportion path unit 32a and an output signal of the integral path unit 32b. The edge detector 31 supplies the DN signal and the UP signal to the multipliers 33 and 34.

The multiplier 33 in the proportion path unit 32a outputs the amount of a frequency offset based on the DN signal and the UP signal. The integrator 35 in the integral path unit 32b integrates the amount of the frequency offset calculated by the multiplier 34 to output the amount of a phase offset. The adder 36 adds an output signal of the multiplier 33 and an output signal of the integrator 35 together. An output signal of the adder 36 includes both the amount of the frequency offset and the amount of the phase offset. The setting code adjuster 29 adds the signal to a frequency setting input code signal to generate a frequency setting code signal.

A digital control loop unit 3 adjusts a digital control signal Dctl by using the frequency setting code signal so that the frequency and phase of a reception signal and the frequency and phase of a VCO signal can be synchronized, respectively.

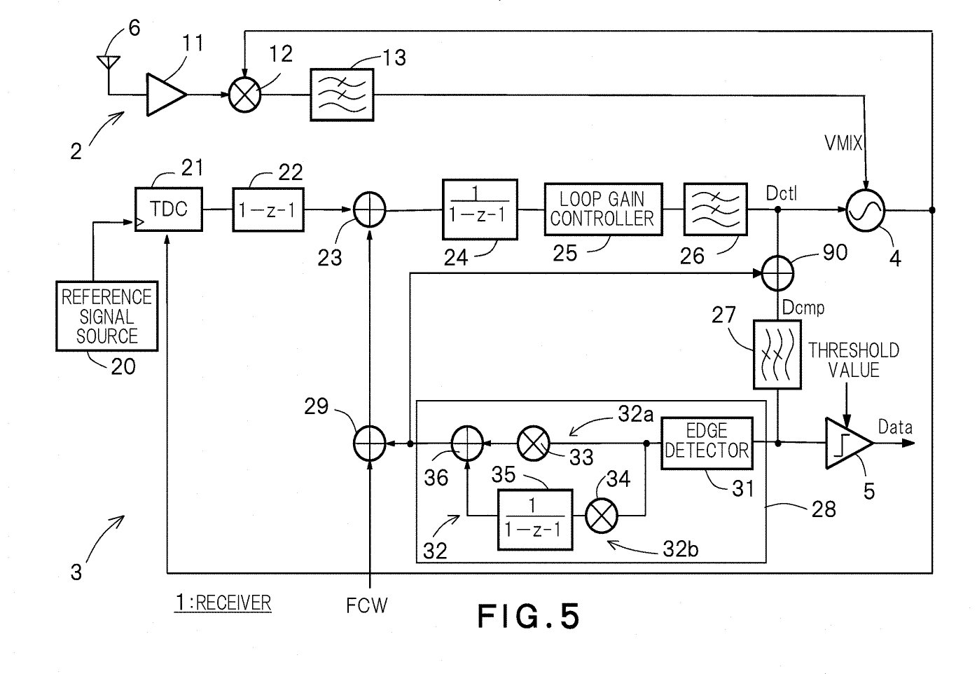

FIG. 6A illustrates signal waveforms of the output signal Dcmp of the direct-current level adjuster 90 and an analog control signal Vctl according to the third embodiment when the frequency offset is present between the transmitter and the receiver 1 that transmits and receives a BPSK signal, and when the frequency offset is not present, respectively. FIG. 6B illustrates signal waveforms of the UP signal and the DN signal. FIG. 6C is a signal waveform chart of the setting frequency FVCO in the digital control loop unit 3.

Solid line waveforms indicate actual signal waveforms and broken line waveforms indicate ideal signal waveforms in FIG. 6A. Since the actual signal waveforms delay in phase with respect to the ideal signal waveforms at the beginning, the UP signal is output so that the frequency offset and a phase offset are adjusted. After that, this time, the actual signal waveforms advance in phase with respect to the ideal signal waveforms so that the DN signal is output. Performing this type of control synchronizes the frequency and phase of the reception signal and the frequency and phase of the VCO signal, respectively.

In this manner, according to the third embodiment, the proportion path unit 32a and the integral path unit 32b are provided in the loop gain controller 32 inside the automatic offset controller 28 so that the amount of the frequency offset and the amount of the phase offset can be detected. Therefore, the shift in frequency and the shift in phase between the transmitter and the receiver 1 can be corrected.

### Fourth Embodiment

A fourth embodiment to be described below is to accelerate correction for a shift in frequency and a shift in phase between a transmitter and a receiver 1.

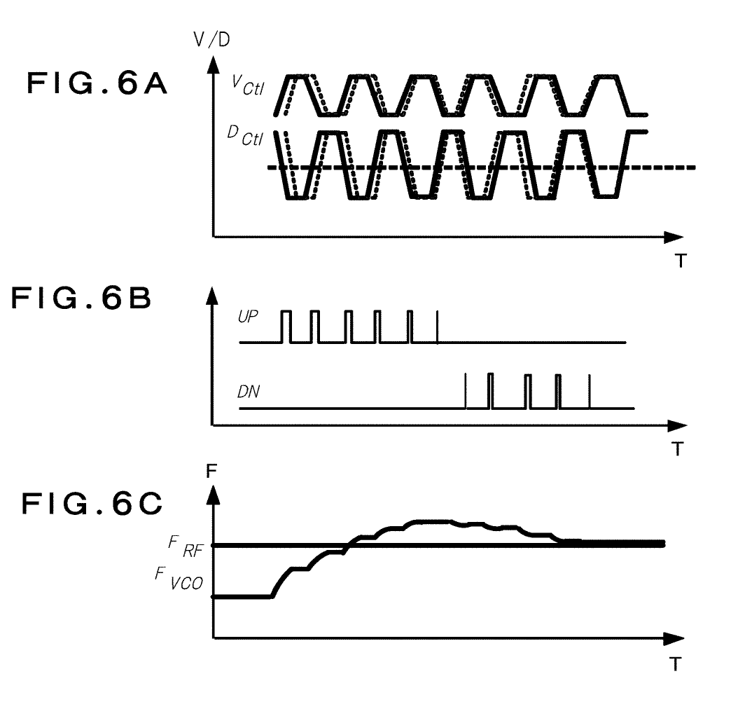

FIG. 7 is a block diagram showing an internal configuration of the receiver 1 in a radio communication device according to the fourth embodiment. The receiver 1 in FIG. 7 includes the receiver 1 in FIG. 5 added with a multiplier 36 and an adder 37. The multiplier 36 multiplies a correction signal output from an automatic offset controller 28, by predetermined gain. The adder 37 supplies a signal including an output signal of the multiplier 36 and a digital control signal Dctl output from a loop gain controller 25, added together, to a voltage controlled oscillator 4. The multiplier 36 and the adder 37 correspond to an adjuster.

Providing the multiplier 36 and the adder 37 can promptly reflect the correction signal generated by the automatic offset controller 28, on the digital control signal Dctl so that the control operation of the voltage controlled oscillator 4 can be accelerated.

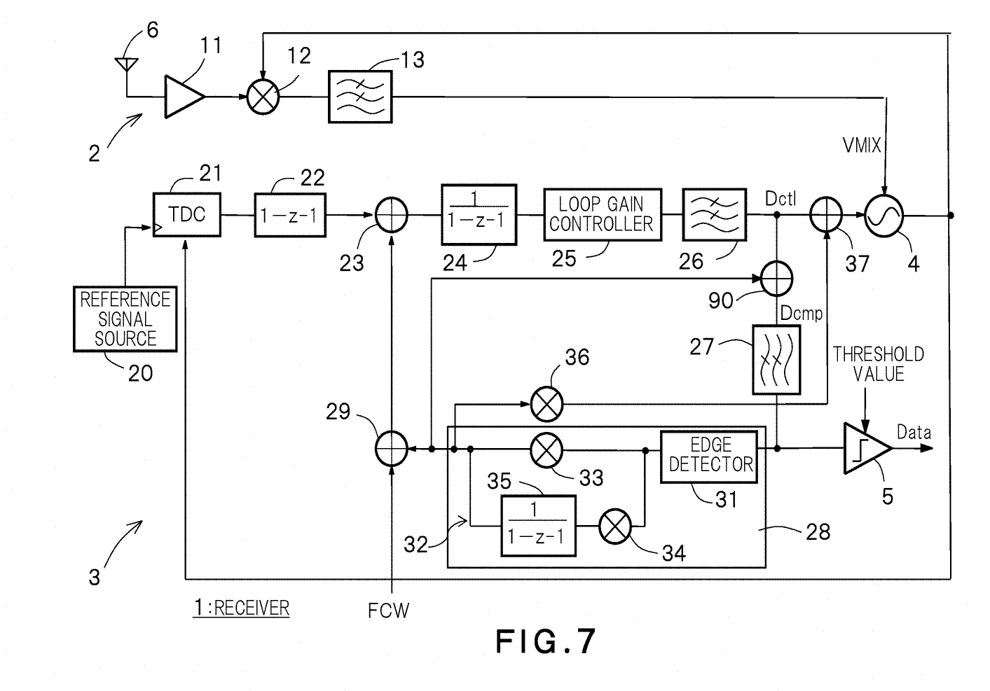

FIG. 8A illustrates signal waveforms of an output signal Dcmp of a direct-current level adjuster 90 and an analog control signal Vctl according to the fourth embodiment when a frequency offset is present between the transmitter and the receiver 1 that transmits and receives a BPSK signal, and when the frequency offset is not present, respectively. FIG. 8B illustrates signal waveforms of an UP signal and a DN signal. FIG. 8C is a signal waveform chart of the setting frequency FVCO in a digital control loop unit 3.

As understood with comparison between FIGS. 8A to 8C and FIGS. 6A and 6C, according to the fourth embodiment, the shift in frequency and the shift in phase between the transmitter and the receiver 1 can be corrected in a shorter time than that according to the third embodiment.

In this manner, according to the fourth embodiment, the correction signal output from the automatic offset controller 28 can be promptly reflected on the digital control signal Dctl through the multiplier 36 and the adder 37, and the control operation of the voltage controlled oscillator 4 can be accelerated so that the shift in frequency and the shift in phase between the transmitter and the receiver 1 can be more promptly corrected.

### Fifth Embodiment

The configuration and operation of the receiver 1 have been described in each of the first to fourth embodiments described above. According to a fifth embodiment to be described below, an exemplary hardware configuration of a radio communication device including a transmitter in addition to the configuration of the receiver 1 according to any of the first to fourth embodiments, will be described. A receiver 1 in the radio communication device according to the fifth embodiment, includes any of the first to fourth embodiments described above, and thus the detailed descriptions thereof will be omitted.

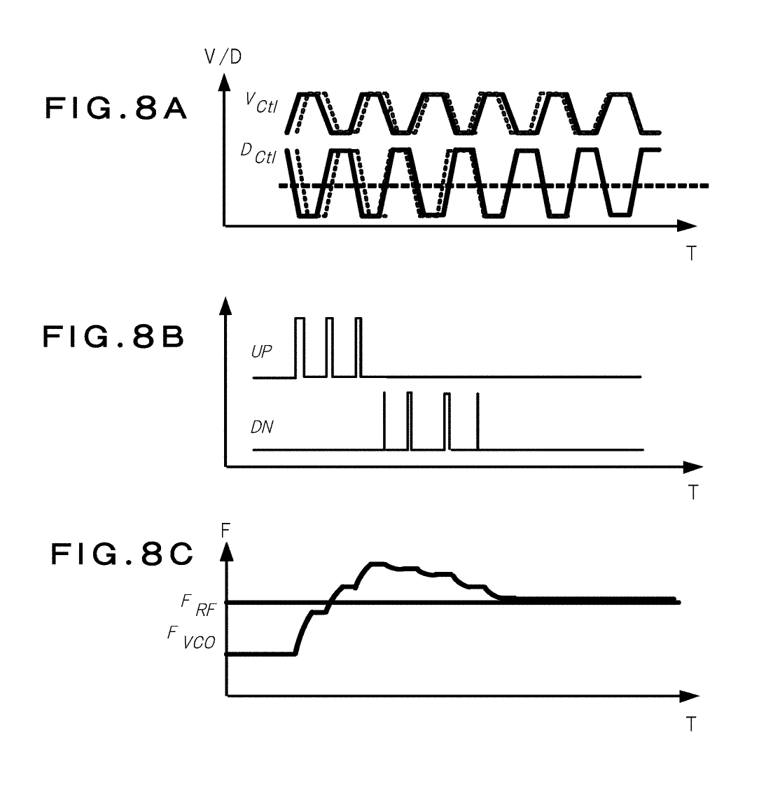

FIG. 9 is a block diagram showing a schematic configuration of the radio communication device 71 according to the fifth embodiment. The radio communication device 71 in FIG. 9 includes a baseband unit 72, an RF unit 73, and an antenna unit 74.

The baseband unit 72 includes a control circuitry 75, a transmission processing circuitry 76, and a reception processing circuitry 77. Each of the circuitries inside the baseband unit 72 performs digital signal processing.

The control circuitry 75 performs, for example, processing of a media access control (MAC) layer. The control circuitry 75 may perform processing of a host network hierarchy of the MAC layer. The control circuitry 75 may perform processing relating to multi-input multi-output (MIMO). For example, the control circuitry 75 may perform, for example, propagation path estimation processing, transmission weight calculation processing, and stream separation processing.

The transmission processing circuitry 76 generates a digital transmission signal. The reception processing circuitry 77 performs processing of analyzing a preamble and a physical header, for example, after performing demodulation and decoding.

The RF unit 73 includes a transmitting circuitry 78 and a receiving circuitry 79. The transmitting circuitry 78 includes a transmission filter not illustrated that extracts a signal in a transmission band, a mixer not illustrated that upconverts the signal that has passed through the transmission filter, into a radio communication frequency by using an oscillation signal of a VCO 4, and a preamplifier not illustrated that amplifies the signal that has been upconverted. The receiving circuitry 79 has a configuration the same as that of the receiver 1 according to any of the first to the fourth embodiment described above. That is, the receiving circuitry 79 includes a TDC 21, an ADPLL unit 80, a reception RF unit 81, and the VCO 4.

The ADPLL unit 80 includes, for example, the digital differentiator 22, the digital subtractor 23, the integrator 24, the loop gain controller 25, the loop filter 26, the channel selection filter 27, the automatic offset controller 28, and the setting code adjuster 29 in FIG. 1A. The reception RF unit 81 includes, for example, the low-noise amplifier 11, the frequency converter 12, and the low pass filter 13 in FIG. 1A.

The VCO 4 is shared by the transmitting circuitry 78 and the receiving circuitry 79 in the RF unit 73 in FIG. 9, but a separate VCO may be provided for each circuitry.

When the antenna unit 74 transmits and receives a radio signal, a switch for coupling any one of the transmitting circuitry 78 and the receiving circuitry 79 to the antenna unit 74, may be provided in the RF unit 73. When this type of switch is provided, the antenna unit 74 can be coupled to the transmitting circuitry 78 during the transmission, and the antenna unit 74 can be coupled to the receiving circuitry 79 during the reception.

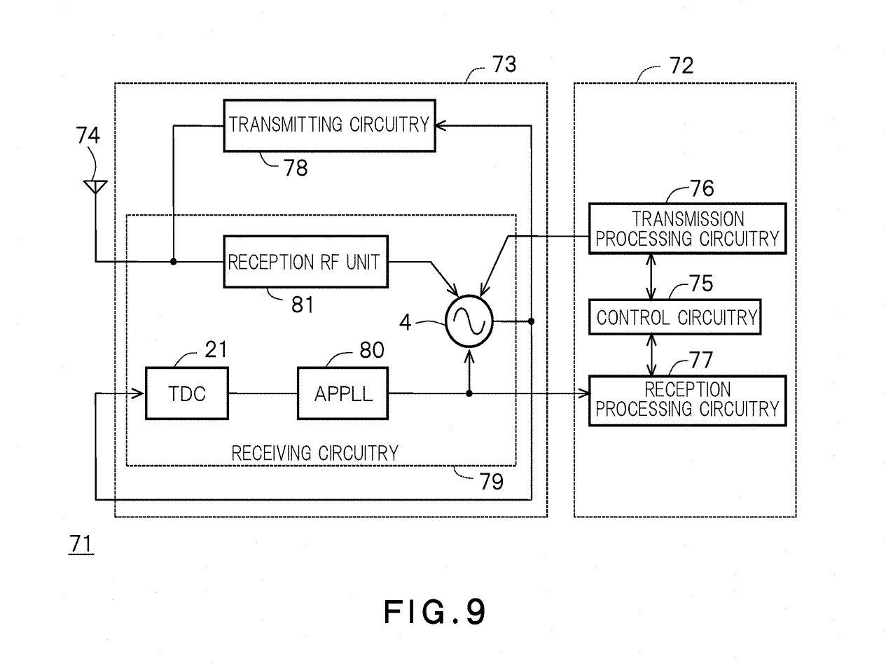

The transmission processing circuitry 76 in FIG. 9 outputs only a single-channel transmission signal, but may separately output an I signal and a Q signal in accordance with a radio system. A block diagram showing another configuration of the radio communication device 71 in this case is, for example, illustrated in FIG. 10. The radio communication device 71 in FIG. 10 is different from that in FIG. 9 in terms of a configuration between a transmission processing circuitry 76 and a transmitting circuitry 78.

The transmission processing circuitry 76 generates a double-channel digital baseband signal (hereinafter, referred to as a digital I signal and a digital Q signal).

A DA conversion circuitry 82 that converts the digital I signal into an analog I signal, and a DA conversion circuitry 83 that converts the digital Q signal into an analog Q signal, are provided between the transmission processing circuitry 76 and the transmitting circuitry 78. The transmitting circuitry 78 upconverts the analog I signal and the analog Q signal by using a mixer not illustrated.

The RF unit 73 and the baseband unit 72 illustrated in each of FIGS. 9 and 10 may be made on one chip, or the RF unit 73 and the baseband unit 72 may be individually made on a separate chip. The RF unit 73 and the baseband unit 72 may partially include a discrete component, and the remaining may include one or a plurality of chips.

Furthermore, the RF unit 73 and the baseband unit 72 may include a software radio reconfigurable with software. In this case, a digital signal processing processor is used so that functions of the RF unit 73 and the baseband unit 72 are at least achieved with the software. In this case, a bus, the processor, and an external interface unit are provided inside the radio communication device 71 illustrated in each of FIGS. 9 and 10. The processor and the external interface unit are coupled through the bus, and firmware operates in the processor. The firmware can be updated with a computer program. The processor operates the firmware so that processing operations of the RF unit 73 and the baseband unit 72 illustrated in each of FIGS. 9 and 10 can be performed.

The radio communication devices 71 illustrated in FIGS. 9 and 10 include only the single antenna unit 74, but the number of the antennas is not particularly limited. For example, a transmission antenna unit 74 and a reception antenna unit 74 may be separately provided or an I signal antenna unit 74 and a Q signal antenna unit 74 may be separately provided. When only one antenna unit 74 is provided, a transmission-and-reception changeover switch at least makes a switch of the transmission and the reception.

The radio communication devices 71 illustrated in FIGS. 9 and 10 can be applied to a stationary radio communication device 71, such as an access point, a wireless router, or a computer, can be applied to a portable radio terminal, such as a smartphone or a mobile phone, can be applied to peripheral equipment, such as a mouse or a keyboard, that performs radio communication with a host device, can be applied to a card-typed member including a radio function built therein, or can be applied to a wearable terminal that performs radio communication of biological information. Various examples of a radio system of the radio communication between the radio communication devices 71 illustrated in FIG. 9 or 10, that can be applied, include, but are not particularly limited to, third generation or later cellular communication, a wireless LAN, Bluetooth (registered trademark), and near-field radio communication.

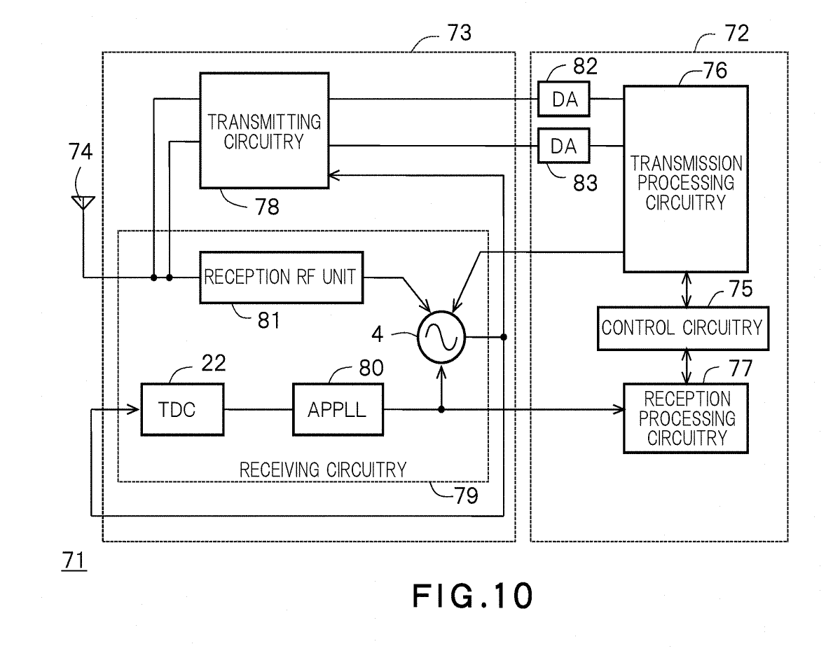

FIG. 11 illustrates exemplary performance of radio communication between a PC 84 being a host device and a mouse 85 being peripheral equipment. Both the PC 84 and the mouse 85 include the radio communication device 71 illustrated in FIG. 9 or 10 built therein. The mouse 85 uses power of a built-in battery to perform the radio communication, and is required to perform the radio communication with power consumption as low as possible because a space in which the battery is built is limited. Accordingly, it is preferable to perform the radio communication by using a radio system capable of low consumption radio communication, such as Bluetooth Low Energy decided in a standard of Bluetooth (registered trademark) 4.0.

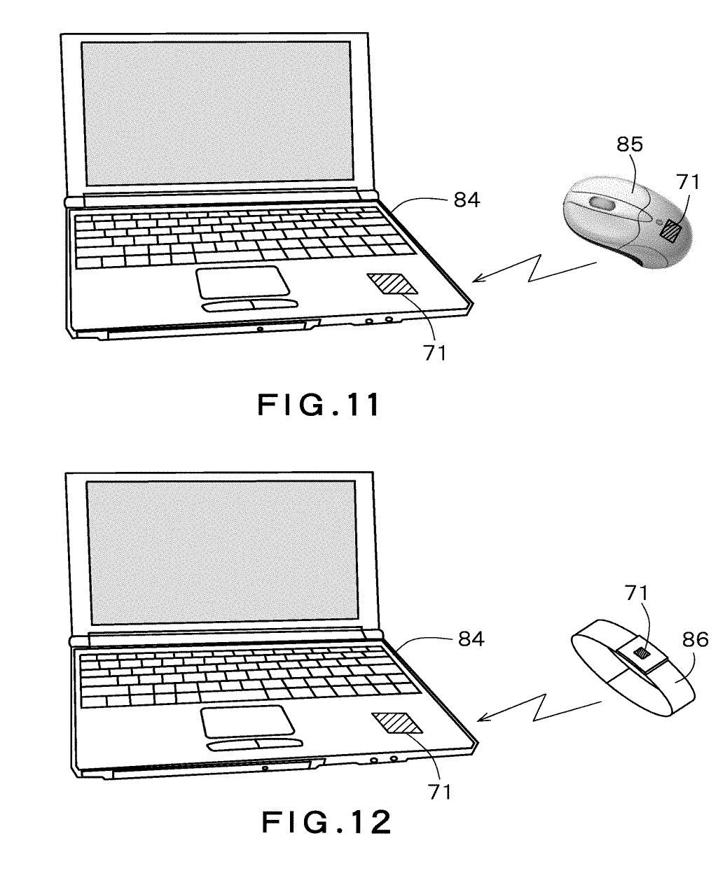

FIG. 12 illustrates exemplary performance of radio communication between a wearable terminal 86 and a host device (for example, the PC 84). The wearable terminal 86 is to be worn on a body of a person, and various examples thereof may include a seal type to be worn on a body, an eyeglasses type and an earphone type to be worn on a body except arms, and a pacemaker to be inserted inside a body, in addition to a type to be worn on an arm illustrated in FIG. 12. Both the wearable terminal 86 and the PC 84 in FIG. 12 also include the radio communication device 71 illustrated in FIG. 9 or 10 built therein. Note that, examples of the PC 84 include a computer and a server. The above radio system capable of the radio communication with low power consumption, such as Bluetooth Low Energy, is also preferably adopted because the wearable terminal 86 is worn on a body of a person and a space for a built-in battery is limited.

When the radio communication is performed between the radio communication devices 71 illustrated in FIG. 9 or 10, the type of information to be transmitted and received through the radio communication is not limited. Note that, the radio system is preferably varied between a case where information including a large amount of data, such as moving image data, is transmitted and received and a case where information including a small amount of data, such as operation information of the mouse 85, is transmitted and received. Thus, there is a need to perform the radio communication in an optimum radio system in response with the amount of information to be transmitted and received.

Furthermore, when the radio communication is performed between the radio communication devices 71 illustrated in FIG. 9 or 10, a notifying unit that notifies a user of an operation state of the radio communication, may be provided. Specific examples of the notifying unit may include display of the operation state on a display device including LEDs, notification of the operation state due to the vibration of a vibrator, and notification of the operation state from audio information due to a speaker or a buzzer.

The receivers 1 described in the respective embodiments described above, may at least partially include hardware or include software. When the configuration including the software is provided, a program for achieving the function of the at least partial receivers 1 may be stored in a storage medium, such as a flexible disk or a CD-ROM, and then may be read and performed by a computer. The storage medium is not limited to a detachably attachable storage medium, such as a magnetic disk or an optical disc, and may be a non-removable storage medium, such as a hard disk or a memory.

The program for achieving the function of the at least partial receivers 1, may be distributed through a communication line, such as the Internet, (including radio communication). Furthermore, the program that has been encrypted, modulated, or compressed, may be distributed through a wired line or a wireless line, such as the Internet, or may be stored in a storage medium and then may be distributed.

While certain embodiments have been described, these embodiments have been presented by way of example only, and are not intended to limit the scope of the disclosures. Indeed, the novel methods and systems described herein may be embodied in a variety of other forms; furthermore, various omissions, substitutions and changes in the form of the methods and systems described herein may be made without departing from the spirit of the disclosures. The accompanying claims and their equivalents are intended to cover such forms or modifications as would fall within the scope and spirit of the disclosures.

1. A radio communication device comprising:
an analog control loop unit to generate an analog control signal which adjusts the phase of a voltage control oscillation signal, from a signal including a reception signal converted in frequency;
a digital control loop unit which has a frequency determined with the frequency of a reference signal and a predetermined frequency setting code signal, has gain higher than the gain of the analog control loop unit, and generate a digital control signal;
a voltage controlled oscillator to generate the voltage control oscillation signal, based on the analog control signal and the digital control signal;
a data slicer to generate a digital signal obtained by digitally demodulating the reception signal, based on a comparison between the digital control signal and a threshold value;
an automatic offset controller to generate a correction signal in response to an error between the frequency of the reception signal and the frequency of the voltage control oscillation signal, based on a time difference between a timing when the digital control signal is equivalent to the threshold value of the data slicer and an ideal timing;
a setting code adjuster to adjust the frequency setting code signal, based on the correction signal; and
a direct-current level adjuster to adjust a direct-current level of the digital control signal, based on the correction signal,
wherein the data slicer compares the digital control signal adjusted by the direct-current level adjuster, with the threshold value.

2. The radio communication device according to claim 1,
wherein the direct-current level adjuster adjusts the direct-current level so that the direct-current level of the digital control signal is constant.

3. A radio communication device comprising:
an analog control loop unit to generate an analog control signal which adjusts the phase of a voltage control oscillation signal, from a signal including a reception signal converted in frequency;
a digital control loop unit which has a frequency determined with the frequency of a reference signal and a predetermined frequency setting code signal, has gain higher than the gain of the analog control loop unit, and generate a digital control signal;
a voltage controlled oscillator to generate the voltage control oscillation signal, based on the analog control signal and the digital control signal;
a data slicer to generate a digital signal obtained by digitally demodulating the reception signal, based on a comparison between the digital control signal and a threshold value;
an automatic offset controller to generate a correction signal in response to an error between the frequency of the reception signal and the frequency of the voltage control oscillation signal, based on a time difference between a timing when the digital control signal is equivalent to the threshold value of the data slicer and an ideal timing;
a setting code adjuster to adjust the frequency setting code signal, based on the correction signal; and
a threshold value adjuster to adjust the threshold value, based on the correction signal,
wherein the data slicer compares the digital control signal with the threshold value adjusted by the threshold value adjuster.

4. The radio communication device according to claim 3,
wherein the threshold value adjuster adjusts the threshold value in response to a variation of a direct-current level of the digital control signal.

5. The radio communication device according to claim 1,
wherein the setting code adjuster adds a frequency setting input code signal input to the radio communication device, to the correction signal to generate the frequency setting code signal.

6. The radio communication device according to claim 1,
wherein the automatic offset controller comprises:
an edge detector to detect the time difference between the timing when the digital control signal is equivalent to the threshold value of the data slicer and the idea timing, for one symbol, to output an error signal in response to the time difference; and
a first loop gain controller to generate the correction signal based on the error signal, and
the loop band of the automatic offset controller is lower than the loop band of the digital control loop unit.

7. The radio communication device according to claim 6,
wherein the error signal output from the edge detector includes the polarity of the time difference and the amount of a phase error, and
the first loop gain controller comprises:
a proportion path unit to multiply the error signal by a predetermined gain to generate a first correction signal in response to a frequency offset;
an integral path unit to integrate a value including the error signal multiplied by the predetermined gain, on a time base to generate a second correction signal in response to a phase offset; and
an adder to add the first correction signal and the second correction signal together to generate the correction signal.

8. The radio communication device according to claim 1,
wherein the analog control loop unit comprises:
a frequency converter to generate a phase difference signal between the reception signal and the voltage control oscillation signal; and
a low pass filter to limit a frequency band of an output signal of the frequency converter to generate the analog control signal, and
the digital control loop unit comprises:
a time-to-digital converter to detect the phase of the voltage control oscillation signal in synchronization with the reference signal;
a digital differentiator to perform differential processing to an output signal of the time-to-digital converter to convert the output signal into frequency information;
a digital subtractor to detect a difference between an output signal of the digital differentiator and the frequency setting code signal to generate a frequency error signal; and
a second loop gain controller to generate the digital control signal based on an output signal of the digital subtractor.

9. The radio communication device according to claim 8, further comprising:
an adjuster to adjust the digital control signal generated by the second loop gain controller, based on the correction signal,
wherein the voltage controlled oscillator generates the voltage control oscillation signal based on the digital control signal adjusted by the adjuster and the analog control signal.

10. The radio communication device according to claim 1,
wherein the reception signal includes a preamble section including a carrier wave signal that has not been modulated and a modulated section including the carrier wave signal modulated with data, for one symbol, and
the automatic offset controller corrects the frequency setting code signal, based on any of the preamble section and the modulated section in the reception signal, for one symbol.

11. The radio communication device according to claim 1, further comprising:
integrated circuitry which comprises the analog control loop unit, the digital control loop unit, the voltage controlled oscillator, the data slicer, the automatic offset controller, the setting code adjuster, and the direct-current level adjuster.

12. The radio communication device according to claim 11, further comprising:
the integrated circuitry; and
at least one antenna.

13. A radio communication device comprising:
an RF unit; and
a baseband unit,
wherein the RF unit comprises transmitting circuitry and receiving circuitry,
the baseband unit comprises transmission processing circuitry and reception processing circuitry,
the receiving circuitry comprises:
an analog control loop unit to generate an analog control signal which adjusts the phase of a voltage control oscillation signal, from a signal including a reception signal converted in frequency;
a digital control loop unit which has a frequency determined with the frequency of a reference signal and a predetermined frequency setting code signal, has gain higher than the gain of the analog control loop unit, and generate a digital control signal;
a voltage controlled oscillator to generate the voltage control oscillation signal, based on the analog control signal and the digital control signal;
a data slicer to generate a digital signal obtained by digitally demodulating the reception signal, based on a comparison between the digital control signal and a threshold value;
an automatic offset controller to generate a correction signal in response to an error between the frequency of the reception signal and the frequency of the voltage control oscillation signal, based on a time difference between a timing when the digital control signal is equivalent to the threshold value of the data slicer and an ideal timing;
a setting code adjuster to adjust the frequency setting code signal, based on the correction signal; and
a direct-current level adjuster to adjust a direct-current level of the digital control signal, based on the correction signal,
wherein the data slicer compares the digital control signal adjusted by the direct-current level adjuster, with the threshold value.

14. The radio communication device according to claim 13,
wherein the direct-current level adjuster adjusts the direct-current level so that the direct-current level of the digital control signal is constant.

15. The radio communication device according to claim 13,
wherein the setting code adjuster adds a frequency setting input code signal input to the radio communication device, to the correction signal to generate the frequency setting code signal.

16. The radio communication device according to claim 13,
wherein the automatic offset controller comprises:
an edge detector to detect the time difference between the timing when the digital control signal is equivalent to the threshold value of the data slicer and the idea timing, for one symbol, to output an error signal in response to the time difference; and
a first loop gain controller to generate the correction signal based on the error signal, and
the loop band of the automatic offset controller is lower than the loop band of the digital control loop unit.

17. The radio communication device according to claim 16,
wherein the error signal output from the edge detector includes the polarity of the time difference and the amount of a phase error, and
the first loop gain controller comprises:
a proportion path unit to multiply the error signal by a predetermined gain to generate a first correction signal in response to a frequency offset;
an integral path unit to integrate a value including the error signal multiplied by the predetermined gain, on a time base to generate a second correction signal in response to a phase offset; and
an adder to add the first correction signal and the second correction signal together to generate the correction signal.

18. The radio communication device according to claim 13,
wherein the analog control loop unit comprises:
a frequency converter to generate a phase difference signal between the reception signal and the voltage control oscillation signal; and
a low pass filter to limit a frequency band of an output signal of the frequency converter to generate the analog control signal, and
the digital control loop unit comprises:
a time-to-digital converter to detect the phase of the voltage control oscillation signal in synchronization with the reference signal;
a digital differentiator to perform differential processing to an output signal of the time-to-digital converter to convert the output signal into frequency information;
a digital subtractor to detect a difference between an output signal of the digital differentiator and the frequency setting code signal to generate a frequency error signal; and
a second loop gain controller to generate the digital control signal based on an output signal of the digital subtractor.

19. The radio communication device according to claim 18, further comprising:
an adjuster to adjust the digital control signal generated by the second loop gain controller, based on the correction signal,
wherein the voltage controlled oscillator generates the voltage control oscillation signal based on the digital control signal adjusted by the adjuster and the analog control signal.

20. The radio communication device according to claim 13,
wherein the reception signal includes a preamble section including a carrier wave signal that has not been modulated and a modulated section including the carrier wave signal modulated with data, for one symbol, and
the automatic offset controller corrects the frequency setting code signal, based on any of the preamble section and the modulated section in the reception signal, for one symbol.
